(19) United States
(12) Patent Application Publication
(10) Pub. No.: US 2021/0398210 A1
(43) Pub. Date: Dec. 23, 2021

(54) SYSTEMS AND METHODS OF TRANSACTION TRACKING AND ANALYSIS FOR NEAR REAL-TIME INDIVIDUALIZED CREDIT SCORING

(71) Applicant: Notto Intellectual Property Holdings, Ebene (MU)

(72) Inventors: Dalumuzi Happy Mhlanga, Ebene (MU); Bhekani Khumalo, Ebene (MU)

(73) Assignee: Notto Intellectual Property Holdings, Ebene (MU)

(21) Appl. No.: 17/349,523

(22) Filed: Jun. 16, 2021

(30) Foreign Application Priority Data
Jun. 17, 2020 (ZA) 2020/03602

(51) Int. Cl. G06Q 40/02; G06Q 30/02; G06N 20/00

(52) U.S. Cl. CPC G06Q 40/025; G06N 20/00; G06Q 30/0282

(57) ABSTRACT

Systems and methods are provided for analyzing user transactions in near-real time to determine a credit score that can be used to indicate the credit worthiness of a user. The system may be capable of communicating with one or more third party systems for obtaining and verifying financial transactions performed by the user. In some implementations, the system may make recommendations for financial products that may be used to improve the services provided to the user.

### RELATED APPLICATIONS

This Application claims foreign priority under 35 U.S.C. § 119 to South African Provisional Patent Application No. 2020/03602, filed Jun. 17, 2020, entitled “A SYSTEM AND A METHOD OF TRANSACTION TRACKING AND ANALYSIS FOR INDIVIDUALIZED CREDIT SCORING AND INTEREST RATE CALCULATION,” which is herein incorporated by reference in its entirety.

### FIELD OF INVENTION

Aspects relate to systems and methods for tracking financial behavior of a user over a period of time.

### BACKGROUND

Determining a consumer's creditworthiness in most emerging markets in the Global South represents a structural challenge across a number of fronts. First, the traditional methods of credit scoring require consumers to take increasing amounts of formal credit. Credit bureaus then analyze how well consumers repay the credit that has been extended to them and build credit scores. Given that there is a substantial lack of formal credit taken by consumers in emerging markets, it means consumers cannot—by definition—build adequate credit histories using current methods, which traps them in a constant state of being “no-hit” and “thin-file” clients. Second, traditional lending decisioning processes are based on, and assume that, applicants are engaged in productive economic activity in the formal sector, thus allowing their economic activity, and more specifically their income, to be captured by way of employment contracts and pay slips. However, the reality in most emerging markets is that a great number (often, the majority) of economically productive adults generate income in the informal sector. As such, the incomes of many of these economically productive adults are consistent and sufficient enough to meet their fundamental needs such as housing, utilities, food, clothing, education expenses, transportation and communication, savings etc. However, these recurring expenses are not formally recorded to allow them to build healthy credit scores, again leaving them in a constant state of being “no-hit” and “thin-file” clients, despite their likely creditworthiness.

### SUMMARY

The inventors appreciate that the inability for consumers in emerging markets to build credit scores translates to limited access to various formal financial products such as insurance, pension, credit more generally, and mortgages specifically. As such, consumers have severely limited opportunities to build wealth, secure downside protection from personal disasters, and save for when they are unable to generate incomes in the later years of life.

Traditional access to financial products is often tied to a “payslip” in which deductions for insurance, retirement savings/pension contribution, and repayments for wealth-building credit such as mortgages is deducted from a consumers' gross income (or “at source” of income). Given that large numbers of consumers in emerging markets do not have payslips, this means that they have limited opportunities to contribute to various kinds of insurance, savings and pension products. Moreover, deductions at source of income infuse financial discipline in consumers (from a behavioral economics perspective), and consumers in emerging markets lose out from the benefits of being automatically opted into deductions from gross income that have long-term financial benefits for them.

Mortgages, specifically, present an opportunity to widen and deepen access to financial products for consumers in emerging markets. Most consumers in emerging markets rent the housing they live in, largely because they cannot access mortgages. However, the rent that they consistently pay could be sufficient to pay off a mortgage provided to them at affordable interest rates. Given that rent—and mortgage repayments—cater to a fundamental need for shelter, very few consumers default on their rent payments. There is, therefore, an opportunity to develop a credit scoring platform for consumers to access mortgages based on how well they pay their rent and other bills.

Increased access to mortgages, on the basis of a novel credit scoring method, could directly lead to increased access to other financial services products—essentially by “flipping” the model by which consumers contribute to insurance, savings and pension. Instead of automatic deductions from payslips, consumers who qualify for mortgages in emerging markets can opt into automatic “top-ups” to their mortgage repayments. Essentially, creditworthy consumers who qualify for mortgages can purchase “hard-bundled” or “tightly-coupled” financial service products that include mortgage, home insurance, life insurance, health insurance, and pension contribution—all of which add to their quality of life, build their wealth, and provide downside protection from personal disasters.

Such an approach would not only vastly expand access to financial services among consumers in emerging markets, it would also help solve for the perennial housing deficit crisis in the Global South, in particular in Africa, Latin America, South-East Asia and among minority groups in countries such as the United States of America. Emerging markets generally have an escalating housing deficit crisis, largely as a result of high population growth and increasing urbanization rates. This crisis is exacerbated by the insufficient housing stock that is currently available, as well as the projected increase in housing stock not meeting the required levels at the current rate of urban population increase. It is well known that the availability, and accessibility to, mortgage financing is one of the most effective ways to provide adequate housing to potential homeowners across the world. In essence, the dearth of long-term finance opportunities, weakened credit markets, unstable macroeconomic environments and limited or non-existent housing finance systems are major obstacles to emerging market's housing market development.

In emerging markets, limited access to long-term mortgage finance is the primary reason for the lack of accessibility, and affordability, of adequate housing for potential homeowners. Additionally, the interest rates on mortgages that are charged in these countries are prohibitively high, compared to those in developed countries, thereby further limiting access to mortgages and exacerbating the housing crisis. These high interest rates are primarily driven by high risk-free rates in emerging markets, and are further compounded by the limited consumer data that is available to financing institutions, thereby making it unfeasible to create accurate risk profiles for potential homeowners.

The key drivers behind the prohibitively high interest rates include: high default rates due to inaccurate customer risk profiles; creditworthy consumers are forced to subsidize non-creditworthy consumers; potential home owners are forced to become price takers due to the high demand of debt facilities and low supply of financing; banks have limited balance sheets as they are unable to create accurate customer risk profiles and determine consumer risk accurately—as such their loan books are not attractive for additional capital funding; and insufficient consumer data impairing the determination of more personalized interest rates.

In addition, financial institutions, such as banks, are not able to determine individualized interest rates. Generally, in order to determine mortgage pricing, these financial institutions consider the customers' credit score (if and when available), the loan amount, the tenure of the loan, and the level of interest that they are charging customers (in general). Typically, this involves placing a customer within certain groupings, or so-called “bands”, of customers who are charged different interest rates. As such, mortgage pricing—and pricing for other financial products such as insurance—is not particularly granular and leads to creditworthy customers paying substantially higher interest rates and premiums than they need to be, and thereby subsidizing those who are less creditworthy or riskier, but are in the same “band”, and who should be paying higher interest rates or premiums than the creditworthy customers.

A specialized credit score that focuses on unlocking mortgage financing for creditworthy consumers in emerging markets, would have an impact in at least three ways: (i) systematically bringing down interest rates on mortgages through building more granular and robust customer risk profiles; (ii) solving for the housing deficit crisis by increasing uptake of mortgages at more affordable interest rates; and (iii) widening access to a broad range of financial products that are tightly coupled/hard-bundled to mortgage repayments.

Thus, the inventors appreciate that there is accordingly a need for systems and methods that track and analyze transactions made by a user that primarily conducts informal economic activity, over a period of time, in order to determine an individualized credit score. In some embodiments, the systems and methods are configured to match this individualized credit score based on transaction data with an optimized and customized bundle of financial products based on the users' risk profile, in substantially real time.

According to one aspect a system is provided. The system comprises a transaction processing module adapted to receive transaction information from one or more entities, the transaction information relating to financial transactions made by a user, at least one memory unit, coupled to the transaction processing module, configured to store the transaction information relating to the financial transactions made by the user and means for determining, for the user, an individually-determined credit score for the user based on, at least in part, the transaction information relating to the financial transactions made by the user.

According to one embodiment, the system further comprising a credit score computation module, coupled to the at least one memory unit, the credit score computation module being configured to interrogate the at least one memory unit and calculate a predicted credit score associated with the user as a function of the transaction data in the at least one memory unit, and to store the resultant predicted credit score in the at least one memory unit. According to one embodiment at least one memory unit is adapted to store data associated with the user, the data including at least one of a group comprising: user identification data, user transaction records, credit score data of the user, customized pricing data associated with the user, savings data of the user, pension contribution data and insurance premium payment data of the user. According to one embodiment, the transaction module is adapted to receive one or more transaction data elements from one or more third party systems. According to one embodiment, the transaction module is configured to poll or scrape, with the user's permission, user transactions from one or more separate user accounts. According to one embodiment, one or more third party systems include at least one or more of the group of systems comprising: a payment provider system, a banking system, a digital payments system and a computer-based system that stores financial transaction data for transactions conducted by the user. According to one embodiment, the transaction module is adapted to receive and process information identifying a proof of payment from a third party, and wherein the system further comprises a verification module that is adapted to verify at least one of the financial transactions made by the user using the information identifying a proof of payment.

According to one embodiment, the verification module is configured to determine an existence of one or more binding legal agreements to support the validity of transactions as bona fide between the user and respective service providers. According to one embodiment, the service providers include at least one of a group comprising a landlord, a utility provider, a school or institution for learning, a banking account or savings institution, or other service provider that accepts a payment for services. According to one embodiment, the system further comprising a machine learning unit, coupled to the at least one memory unit and the credit score computation module, the machine learning unit being configured to train a machine learning model to optimize credit score coefficients using data associated with a plurality of other users. According to one embodiment, the machine learning unit is configured to store resultant data in the at least one memory unit for future interrogation by the credit score computation module to determine another credit score.

According to one embodiment, the system further comprising a pricing computation module, coupled to the at least one memory unit, the pricing computation module being configured to interrogate the at least one memory unit and calculate optimal pricing associated with the user as a function of a group comprising credit store data, pricing models for one or more financial products and preselected macroeconomic indicators and wherein the pricing computation module is configured to store the calculated optimal pricing store for each user across financial products in the at least one memory unit. According to one embodiment, the system further comprises a recommendations module, coupled to the at least one memory unit, and wherein the recommendations module is adapted to poll product information from at least one of a group comprising external financial services providers, pension providers, and insurance providers and wherein the recommendations module is configured to compute personalized bundled product recommendations for a respective user within the constraints of the respective user's affordability and their individualized credit score. According to one embodiment, the system is configured to capture and categorize each successive transaction made by the user, and triggering, responsive to the successive transaction, a recalculation of the user's credit score by the credit score computation module, and the recalculation of the user's customized pricing for loan, insurance and savings products by the pricing computation module and the recalculation of the user's recommendations by the recommendations module.

According to one aspect a computer-implemented method is provided. The method comprises receiving transaction information from one or more entities, the transaction information relating to financial transactions made by a user, storing, in a memory unit, the transaction information relating to the financial transactions made by the user and determining for the user in substantially real-time an individually-determined credit score for the user based on, at least in part, the transaction information relating to the financial transactions made by the user.

According to one embodiment, the method, further comprising an act of predicting the individually-determined credit score associated with the user as a function of the transaction data in the memory unit, and to store the resultant predicted credit score in the at least one memory unit. According to one embodiment, the method, further comprising, storing, by the memory unit, data associated with the user, the data including at least one of a group comprising: user identification data, user transaction records, credit score data of the user, customized pricing data associated with the user, savings data of the user, pension contribution data; and insurance premium payment data of the user. According to one embodiment, the method further comprising receiving one or more transaction data elements from one or more third party systems.

According to one embodiment, the method further comprising polling, with the user's permission, user transactions from one or more separate user accounts. According to one embodiment, one or more third party systems include at least one or more of the group of systems comprising: a payment provider system, a banking system, a mobile money account system, a digital payments system, and a computer-based system that stores financial transaction data for transactions conducted by the user. According to one embodiment, the method further comprising receiving and processing information identifying a proof of payment from a third party and verifying at least one of the financial transactions made by the user using the information identifying a proof of payment. According to one embodiment, the method further comprising determining an existence of one or more binding legal agreements to support the validity of transactions as bona fide between the user and respective service providers. According to one embodiment, service providers include at least one of a group comprising a landlord, a utility provider, a school or institution for learning, a banking account or savings institution, or other service provider that accepts a payment for services. According to one embodiment, the method further comprising training a machine learning unit to optimize credit score coefficients using data associated with a plurality of other users.

According to one embodiment, the method further comprising storing, by the machine learning unit, resultant data in the at least one memory unit for future interrogation to determine another credit score. According to one embodiment, the method further comprising interrogating the one memory unit and calculating optimal pricing associated with the user as a function of a group comprising credit store data, pricing models for one or more financial products and preselected macroeconomic indicators and storing the calculated optimal pricing store for each user across financial products in the memory unit. According to one embodiment, the method further comprising polling product information from at least one of a group comprising external financial services providers, pension providers, and insurance providers and computing personalized bundled product recommendations for a respective user within the constraints of the respective user's affordability and their individualized credit score. According to one embodiment, the method further comprising capturing and categorizing each successive transaction made by the user, and triggering, responsive to the successive transaction, a recalculation of the user's credit score by the credit score computation module, and the recalculation of the user's customized pricing for loan, insurance and savings products by the pricing computation module and the recalculation of the user's recommendations.

According to one aspect a method is provided. The method comprises capturing user transactions via an API gateway that is integrable with at least one payment or transaction tracking method, storing data associated with the user, including user identification data, user transaction records, user credit score data, user customized pricing data, user recommendations, and user savings data, processing and categorizing user transactions into groups including rental payments, bill payments, savings payments and storing the resultant transaction data, calculating a credit score associated with the user as a function of the transaction data and storing the resultant credit score data and training a machine learning model to optimize credit score coefficients as a function of the data associated with each of the plurality of the other users and storing the resultant data for future credit score calculations.

According to one embodiment, the method further comprising calculating an optimized pricing associated with the user as a function of the credit score data, available financial products provided by financial institutions and storing the resultant customized pricing data. According to one embodiment, the method further comprising creating personalized bundled product recommendations within the constraints of the user's affordability and individualized credit score, based on the products offered by the financial services, insurance and pension providers. According to one embodiment, each transaction made by a user is captured and categorized, and each transaction prompts a recalculation of the user's credit score and the recalculation of the user's customized pricing and bundled product recommendations.

According to one aspect a method is provided. The method comprises capturing user transactions via an API gateway that is integrable with at least one payment or transaction tracking method, storing data associated with the user, including user identification data, user transaction records, user credit score data, user customized pricing data, user recommendations, and user savings data, processing and categorizing user transactions into groups including for an extant bundled financial product that the user opts into (i.e., mortgage repayments, pension contribution payments, insurance premium payments), rental payments, bill payments, savings payments and storing the resultant transaction data, calculating a credit score associated with the user as a function of the transaction data and storing the resultant credit score data and training a machine learning model to optimize credit score coefficients as a function of the data associated with each of the plurality of the other users and storing the resultant data for future credit score calculations.

According to one embodiment, the method further comprising calculating an optimized pricing associated with the user as a function of the credit score data, available financial products provided by financial institutions and storing the resultant customized pricing data. According to one embodiment, the method further comprising creating personalized bundled product recommendations within the constraints of the user's affordability and individualized credit score, based on the products offered by the financial services, insurance and pension providers. According to one embodiment, each transaction made by a user is captured and categorized, and each transaction prompts a recalculation of the user's credit score and the recalculation of the user's interest rate and bundled product recommendations.

According to one aspect, there is provided a transaction tracking and analysis system for individualized credit scoring and matching users with customized financial product bundles, the system characterized in having:
computer implemented means for capturing transactions made by a user. This may be achieved via (for example) by an a) upload of proof of bill payment via web, mobile App or social media platform such as WhatsApp messenger, b) direct integration, with the users' permission, which grants the transaction service permission to poll/scrap the user's transactions directly from their payment provider, bank accounts or various transaction accounts (such as mobile money or digital payments accounts);
at least one memory unit, configured to store data associated with the user, the data including user identification data, user transaction records, the user's credit score data, the user's customized pricing data (including individual interest rates and premiums), the user's savings data, the user's pension contribution data, and the user's insurance premium payments data;
a transaction processing module, coupled to the memory unit. The transaction processing module being configured to process and categorize transactions made by the user into groups including, rental payments, bill payments (such as utilities, school fees, mobile phone) mortgage payments, pension contribution payments, insurance premium payments and savings payments, and to store the resultant transaction data in the memory unit;
a verification/fraud prevention module, which verifies the authenticity of proofs of payment (for users who upload proofs of bill payment), and checks the existence of binding legal agreements to support the validity of transactions as bona fide, between the user and respective service providers (such as landlord, utility provider, school, savings association, etc.)
a credit score computation module, coupled to the memory unit, the credit score computation module being configured to interrogate the memory unit and calculate a predicted credit score associated with the user as a function of the transaction data in the memory unit, and to store the resultant predicted credit score in the memory unit;
a machine learning unit, coupled to the memory unit and the credit score computation module, the machine learning unit being configured to train a machine learning model to optimize the credit score coefficients using the data associated with each of the plurality of the other users, and to store the resultant data in the memory unit for future interrogation by the credit score computation module;
a pricing computation module, coupled to the memory unit, the pricing computation module being configured to interrogate the memory unit and calculate optimal pricing associated with the user as a function of: a) the credit score data in the memory unit; b) the pricing models for various financial products provided by financial services providers (including banks, insurance companies, pension funds, lenders, and other similar institutions); and c) preselected macroeconomic indicators, and to store the resultant optimal pricing for each user across financial products in the memory unit;
and a recommendations module, coupled to the memory unit being configured to poll product information from external financial services providers and pensions and insurances providers and compute personalized bundled product recommendations within the constraints of the user's affordability and their individualized credit score.

wherein each transaction made by the user is captured and categorized, thereby prompting the recalculation of the user's credit score by the credit score computation module, and the recalculation of the user's customized pricing for loan, insurance and savings products by the pricing computation module and the recalculation of the user's recommendations by the recommendations module.

According to another aspect there is provided a computer implemented method for transaction tracking and analysis for individualized credit scoring and matching users with customized financial product bundles at the pre-qualification phase (the qualifying event being defined as the issuance of a mortgage to a creditworthy consumer), the method including the steps of:
capturing user transactions via an API gateway that is integrable with at least one payment or transaction tracking method (including uploads of proofs of payment);
storing data associated with the user, including user identification data, user transaction records, user credit score data, user customized pricing data, user recommendations, user savings data;
processing and categorizing user transactions into groups including rental payments, bill payments (including utilities, school fees, transportation, grocery purchase, phone credit, etcetera . . . ), savings payments and storing the resultant transaction data;
calculating a credit score associated with the user as a function of the transaction data and storing the resultant credit score data;
training a machine learning model to optimize credit score coefficients as a function of the data associated with each of the plurality of the other users and storing the resultant data for future credit score calculations; and
calculating an optimized pricing associated with the user as a function of the credit score data, available financial products provided by financial institutions and storing the resultant customized pricing data;
creating personalized bundled product recommendations within the constraints of the user's affordability and individualized credit score, based on the products offered by the financial services, insurance and pensions providers.

wherein each transaction made by a user is being captured and categorized, thereby prompting the recalculation of the user's credit score and the recalculation of the user's interest rate and bundled product recommendations.

According to another aspect there is provided a computer implemented method for transaction tracking and analysis for individualized credit scoring and matching users with customized financial product bundles at the post-qualification phase (the qualifying event being defined as the issuance of a mortgage to a creditworthy consumer), the method including the steps of:
capturing user transactions via an API gateway that is integrable with at least one payment or transaction tracking method (including uploads of proofs of payment, or integration with transaction accounts);
storing data associated with the user, including user identification data, user transaction records, user credit score data, user customized pricing data, user savings data, user pension contribution data, user insurance premium payments data, user recommendations;
processing and categorizing user transactions into groups including for the extant bundled financial product that the user opts into (i.e., mortgage repayments, pension contribution payments, insurance premium payments) and bill payments (including utilities, school fees, transportation, grocery purchase, phone credit, etcetera . . . ), and savings payments, and storing the resultant transaction data;
calculating a credit score associated with the user as a function of the transaction data and storing the resultant credit score data;
training a machine learning model to optimize credit score coefficients as a function of the credit score data associated with each of the plurality of the other users and storing the resultant data for future credit score calculations; and
calculating optimized pricing associated with the user as a function of the credit score data, available financial products provided by financial institutions and storing the resultant customized pricing data;
creating personalized bundled product recommendations within the constraints of the user's affordability, the financial product that they are already opted into, and based on new or updated products offered by the financial services and insurance and pensions providers.

wherein each transaction made by a user is being captured and categorized, thereby prompting the recalculation of the user's credit score and the recalculation of the user's customized pricing and bundled product recommendations.

### BRIEF DESCRIPTION OF DRAWINGS

A non-limiting embodiment of the invention shall now be described with reference to the accompanying Figures wherein:

FIG. 1 shows a transaction tracking, analysis, and recommendation system at the pre-qualification phase for users in accordance with some embodiments.

FIG. 2 shows a transaction tracking, analysis, and recommendation system at the post-qualification phase for users in accordance with some embodiments.

FIG. 3 shows a transaction processing module/service in accordance with some embodiments;

FIG. 4 shows a transaction tracking and analysis system architecture in accordance with some embodiments;

FIG. 5 shows an internal system architecture of the system illustrated in FIG. 4; and

FIG. 6 shows the network infrastructure for supporting the system illustrated in FIG. 4.

FIG. 7 shows an example overview/flowchart showing relations between transactions, credit scoring, external systems, pricing and recommendation services according to various embodiments;

FIG. 8 shows an example artificial neural network (ANN) for credit score calculation;

FIG. 9 shows a process by which independent variables are assigned weightings to compute a credit score; and

FIG. 10 shows a more detailed example of an ANN that can be used for credit score calculation.

### DETAILED DESCRIPTION

As discussed above, there is a need for systems and methods that track and analyze transactions made by a user that primarily conducts informal economic activity, over a period of time, in order to determine an individualized credit score. In some embodiments, the systems and methods are configured to match this individualized credit score based on transaction data with an optimized and customized bundle of financial products based on the users' risk profile and affordability, in substantially real time.

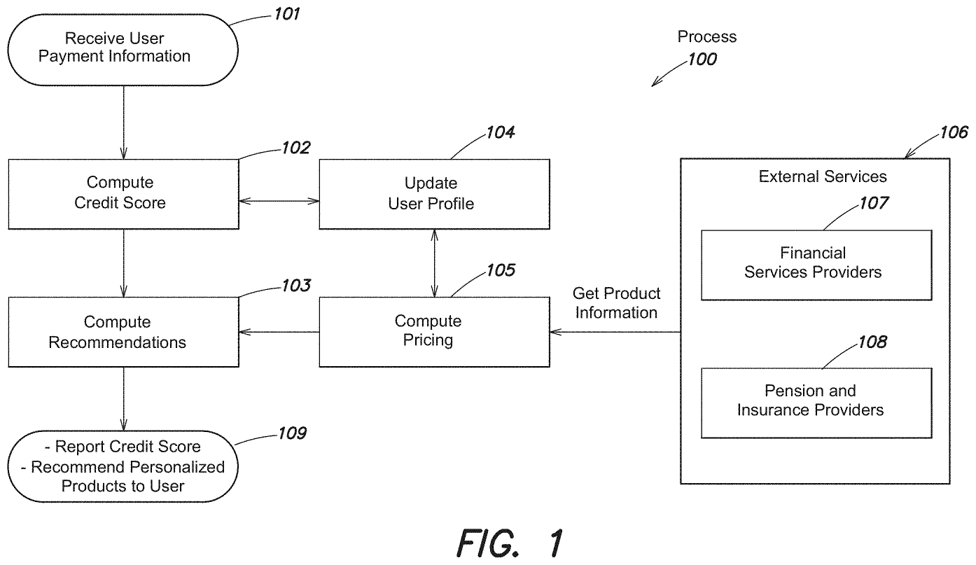

FIG. 1 shows a transaction tracking, analysis, and recommendation system at the pre-qualification phase for users in accordance with some embodiments. In particular, FIG. 1 illustrates an example flowchart and process 100 that is specific to the pre-qualification phase for users who are building their credit scores, to qualify for a mortgage and receive a customized and optimized financial product bundle that they opt into at the point of qualifying for a mortgage.

In FIG. 1, at block 101, the system receives user payment information. For example, the system may receive information from one or more sources such as payments made through a payment processing service, transactions identified within a banking, mobile money or digital payments system, credit card, or other type of system. At block 102, the system computes a credit score for the individual user. In some embodiments, this may be determined based on the transaction information received regarding the user's payment history. Such a credit score may be calculated in real time as transactions are made by the user. At block 104, the system may update the user profile, such as storing any updated transaction information or information about the user.

At block 103, in an optional embodiment, the system computes recommendations for the user for one or more products that may be recommended to the user. In some instances, the system may be coupled to one or more external services (e.g., external services 106) that offer additional products to the user. For example, it should be appreciated that the user may be capable of paying their mortgage which includes a bundled service such as those that might be offered by financial service providers 107 and pension and insurance providers 108, or any other service provider that may be bundled with the person's mortgage. In some embodiments, based on the user's payment history, recommended products may be presented to the user (e.g., within a graphical user interface, app, message, email or other method) based on a real time analysis of that user's transaction information. In some embodiments, the system may be configured to compute pricing (e.g., at block 105) in real time based on the updated user information which includes real-time transactions.

At block 109 the system may report to the user or any entity such as a third-party system, bank, lender or other entity, the user's credit score. In addition, the system may also recommend personalized products to the user based on the real-time analysis of the user's transaction information.

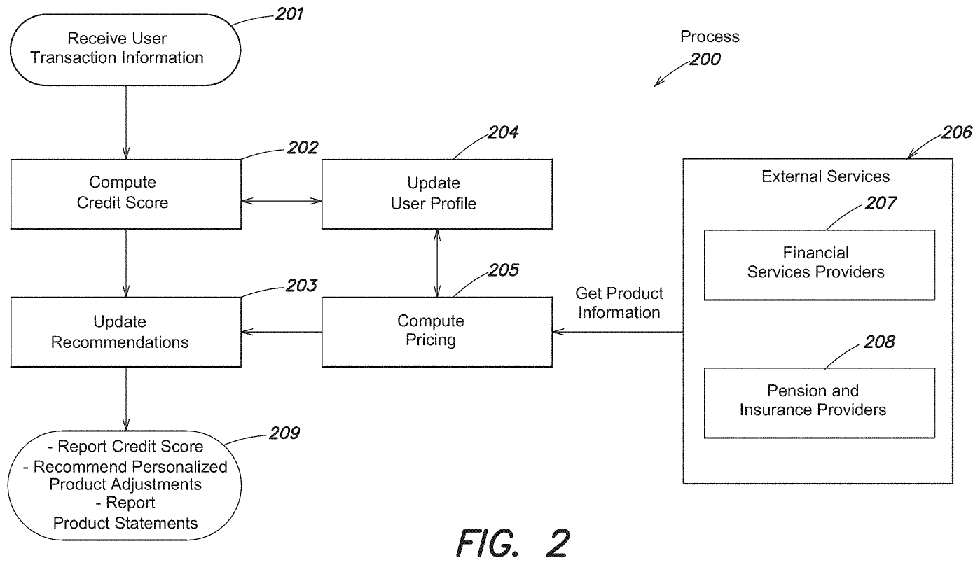

FIG. 2 shows an example transaction tracking, analysis, and recommendation system at the post-qualification phase for users in accordance with some embodiments. In particular, FIG. 2 illustrates an example flowchart and process 200 that is specific to the post-qualification phase for users who have qualified for a mortgage, are making payments towards their customized and optimized financial product bundle but are also seeking to further optimize it based on changes (in substantially real-time) to their credit scores and the available financial products.

In FIG. 2, at block 201, the system receives user payment information. For example, the system may receive information from one or more sources such as payments made through a payment processing service, transactions identified within a banking system, digital payments system, credit card, or other type of system. At block 202, the system computes a credit score for the individual user. In some embodiments, this may be determined based on the transaction information received regarding the user's payment history. Such a credit score may be calculated in real time as transactions are made by the user, and this credit score may be updated and used to determine an updated product offering. At block 204, the system may update the user profile, such as storing any updated transaction information or information about the user.

At block 203, in an optional embodiment, the system computes recommendations for the user for one or more products that may be recommended to the user. In some instances, the system may be coupled to one or more external services (e.g., external services 206) that offer additional products to the user. For example, it should be appreciated that the user may be capable of paying their mortgage which includes a bundled service such as those that might be offered by financial service providers 207 and pension and insurance providers 208, or any other service provider that may be bundled with the person's mortgage. In some embodiments, based on the user's payment history, recommended products may be presented to the user (e.g., within a graphical user interface, app, message, email or other method) based on a real time analysis of that user's transaction information. In some embodiments, the system may be configured to compute pricing (e.g., at block 205) in real time based on the updated user information which includes real-time transactions.

At block 209 the system may report to the user or any entity such as a third-party system, bank, lender or other entity, the user's credit score. In addition, the system may also recommend personalized products to the user based on the real-time analysis of the user's transaction information. These recommendations may be adjusted product recommendations based on updated activity for the user. In one example, the user's good transaction activity may justify them getting a lower rate on certain products or receiving some preferential pricing for a particular product. Further, the system may output one or more product statements to which the user has previously enrolled in.

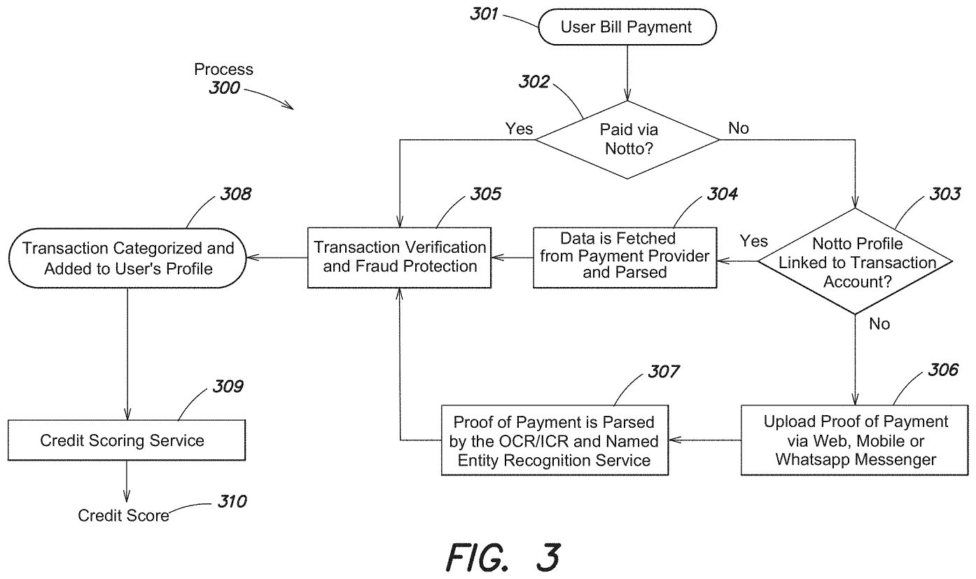

FIG. 3 shows a transaction processing module/service in accordance with some embodiments. In particular, FIG. 3 illustrates an example transactions processing flowchart and process 300, at both the pre-qualification and post-qualification phases, for various payments including rent, bills, mortgage repayment, insurance premiums, pension contribution, savings, etc.

At block 301, the user performs a bill payment process. At block 302, the system determines whether or not the system is used to pay the bill. For instance, in some embodiments, the system itself may be used by an end user to make bill payments. In this case, each bill payment transaction is recorded within the service (e.g., the Notto service), and the information is stored along with the user's profile.

However, if the system is not used to pay a bill, at block 303, and external transaction account may be linked to the service for the purpose of ingesting transaction data. If the user profile is linked to the external transaction account at block 303, then data is fetched from the payment provider and is parsed at block 304. At block 305, the system performs a transaction verification and fraud protection process. For instance, certain transactions may be verified as legitimate prior to being used for adjusting a person's credit score.

If the profile is not linked to a transaction account at block 303, the system may still be capable of processing external transactions. Such information may be ingested by the system by, for example, at block 306 uploading a proof of payment via the web, a mobile device, WhatsApp messenger or other communication method used to transfer information. Further, the system may receive a proof of payment which is parsed by an Optical Character Recognition/Intelligent Character Recognition module and Named Entity Recognition service. Such information may be used to verify the transactions and prevent fraud at block 305.

At block 308, the transaction is categorized and added to the user's profile. Information within the user profile which includes transaction information may be used by a credit scoring service 309 to calculate a credit score 310 based on the user's activity.

In some embodiments, when a user wants to make a payment that should be recorded in a service (sometimes referred to herein as a “Notto” service), they can either pay via the Notto service in which case the Transactions service will categorize the transaction, verify the transaction and record it on the user's profile directly without any additional steps. If the user pays via a different payment provider, the user can grant the Notto service permission to access their transaction account, in which case the Transactions service will either receive a webhook from the transaction account when the relevant transactions are made or periodically query the transaction account's service to get the latest transactions after which the payments will be categorized, verified, and recorded to the user's profile. If the user pays via a different payment provider but has not granted the Notto service permission to access their transaction accounts then they will need to upload a proof of payment then the Transactions service will parse the proof of payment using a combination of Optical Character Recognition/Intelligent Character Recognition and Named Entity Recognition and extract the relevant transactions, these will then be verified and saved to the user's profile. In some implementations, all these are serverless functions which together make up a single microservice designated as the Transactions service.

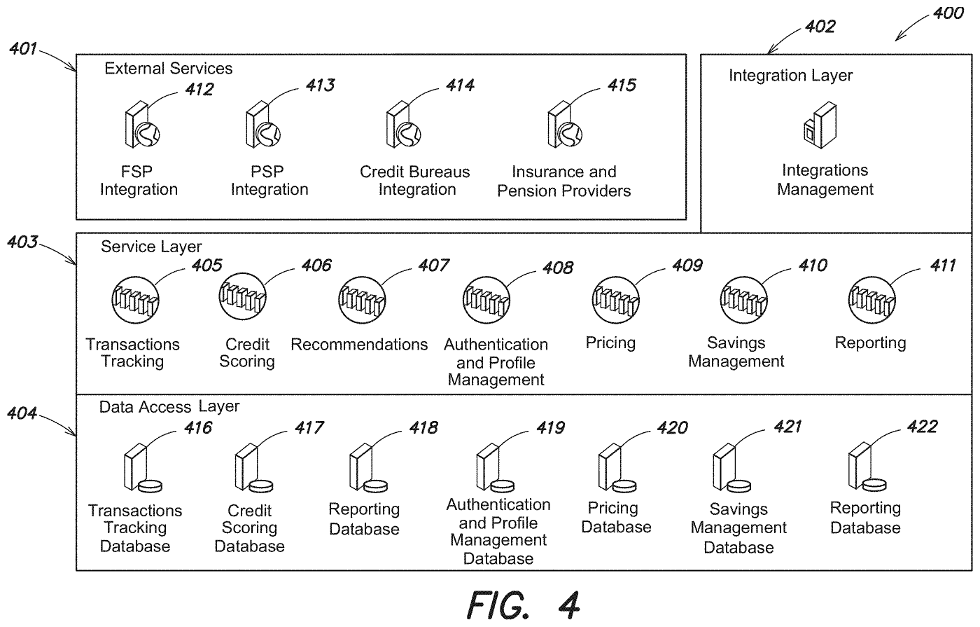

FIG. 4 illustrates an overview of a transaction tracking and analysis system's architecture infrastructure 400 in accordance with some embodiments. The system infrastructure 400 includes three layers, namely, an Integration layer 402 which constitutes the services that are concerned with communications between the system service provided (e.g., the “Notto” service) and any External Services 401 provided by the outside world. The outside world in this case particularly includes but is not limited to Financial Services Providers who grant the mortgage loans, Pensions and Insurances providers, other credit bureaus and Payment services providers. A Service layer which constitutes all the Notto internal services and a Data Access layer 404 which is responsible for data storage and management. The relevant data is stored, accessed, and updated in the Data Access layer 404. In some implementations, the services in the Service layer 403 has its own corresponding database specifically assigned to it to persist its own internal data, this allows for the use of database technologies specifically suited to its unique functionality.

Service layer 403 comprises multiple service modules, each of which contain their own unique internal logic. The service modules in the Service layer 403 includes a Transactions Processing service 405, a Credit Scoring service 406, an Authentication and Profile Management service 408, a Pricing service 409, a Savings Management service 410, a Reporting service 411 and a Recommendations service 407. In addition, each service module exposes an internal API that the other service modules can use to gain access to its functionality. For example, the Credit Scoring service 406 has internal logic, specifically to calculate credit scores and to store the resultant credit scoring data, while also exposing an internal API to allow services such as the Authentication and Profile Management service 408 to enquire about a particular user's credit score at any given instance.

The Integration Layer 402 manages connections to the external services that the internal service modules can interact with to enable numerous functionalities, such as allowing communication with external credit bureaus, to enable such bureaus to acquire a user's existing credit information if any, communication with Financial Service Providers (“FSPs”) to acquire information about products information, to give FSPs access to a user's credit score and to update a user's account in the post-qualification phase, or communication with insurance and pensions providers, to acquire information about product information, as well as track users' accounts in the post-qualification phase.

More specifically, the system may be integrated with FSPs (via FSP Integration 412), who are the primary users of credit profiles; Payment Service Providers (“PSPs”) (via PSP Integration 413), who facilitate payments via various payment methods; other Credit Bureaus (e.g., via Credit Bureaus Integration 414), who provide a portion of the information used for the credit calculation for consumers who already have a credit profile; and Insurance and Pension Providers (e.g., Insurance and Pension Providers 415 systems), who are the partners who provide the invention's home/life/medical insurance and pension value added services at the point of qualification for a mortgage, and in the post-qualification phase.

The above services are supported by an array of databases with each service having its own database, as reflected on the Data Access layer, including a Transactions Database 416 which stores all the information relating to transactions and any other data needed by the Transactions service 405 such as rent payments transactions, a Credit Scoring Database 417 which stores all the data used and produced by the Credit Scoring service 406 for example time series data of the information used to calculate credit scores, an Authentication and Profile Management Database 419 which stores all the data relating to the Authentication and Profile Management service 408, for example information about user roles and permissions, Pricing Database 420 which stores all the data used and generated by the Pricing service 409 and a Savings Management Database 421 which stores information relating to the Savings Management service 410, for example profiles for each user's savings and where they are held, a Reporting Database 422 which fetches data from the other service modules and stores the data to be used for reporting by the Reporting service 411. Although separate databases may be used it should be appreciated that information may be stored in one or more databases and/or stored in a variety of formats.

The system 1 relies on its internal Transaction Processing service to keep an account of transactions. The system creates a digital profile that a user will use to make payments, such as rental and bill payments, through the various PSPs. The system is used for transaction tracking, and as an issuing service, makes requests to the other services within the system, and is not itself responsible for settling the payments. This allows for a variety of payment providers and external user transaction accounts (such as mobile money or digital payments accounts) to be integrated into the system and be used, thereby allowing the system to support payments and have access to transaction data through several social platforms, such as payments via WhatsApp, USSD and other digital methods.

The system has a wide range of flexibility and permits payments to be made from multiple PSPs as long as a record of the payments can be sent to the Transaction Processing service. If the transactions are obtained directly from the PSP then they are verified and approved by the PSP before being sent to the Transaction Processing service. The Transaction Processing service then logs the transactions and issues service requests out to the Savings Management service in the case of savings, and to the Credit Scoring service for real time credit score calculations. Tracking of the transactions is done in real time, alternatively, with a delay, provided they are provided to the relevant service with the required information to enable reconciliation and categorization of the relevant payments. Offline transactions are added to a Message Queuing Telemetry Transport (MQTT) message queue which is pushed to the service for processing when the device is back online.

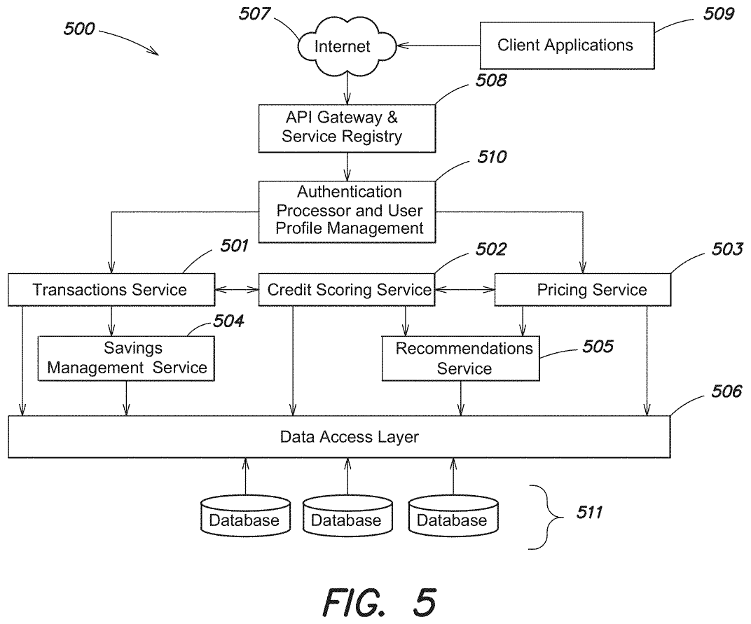

FIG. 5 shows a flow chart reflecting an internal system architecture 500 of the system illustrated in FIG. 4. As shown in FIG. 5, typically, the relevant clients access their specific profiles via any of the applicable Client Applications (item 509), that are accessible via an electronic device such as a cell or mobile phone, their personal computer, or a terminal provided at an agent, merchant location or member financial institution. These Client Applications connect to an API via the Internet 507 (e.g., an API Gateway and Service Registry 508). As a central interface connecting clients with the relevant service modules, the API gateway manages crucial security and administration tasks such as authentication, input validation, metrics collection, load balancing and response transformation. The profile of the client is then verified by the Authentication and Profile Management service (e.g., item 510) in accordance with pre-defined authorization criteria. The Transaction Processing service (e.g., item 501) then accepts the transaction data, processes it and stores the information in its corresponding database.

The Transaction Processing service (e.g., item 501) integrates with external payments service providers or with transaction accounts (for which permission is granted by the user) to track and categorize all transactions, and the data for each respective client is stored in the relevant database with references to the client's specific profile. The Transaction Processing service internally has a transaction verification module which connects to various PSPs and transaction accounts to check the validity of transactions. This allows the Client Applications to use the PSP that best serves the specific client's needs, for example, those clients that typically don't have bank accounts or access to mobile applications. The ability to accommodate PSPs such as social media payment, such as WhatsApp, and USSD, allows for detailed transaction tracking by the system. For example, users can also register at a retail location where they normally make payments towards their electricity using a voucher system. The system would integrate with the existing voucher payment system. When users make cash payments for electricity, they can similarly make rental payments using the same voucher system, which is then captured by the system. This integration with existing methods of payment allows the system to capture the transactions made by the client and use the relevant payment data for other corresponding services, such as the Credit Scoring service (e.g., item 502).

After the records of the relevant transactions have been processed by the Transactions Processing service, the service issues a message to the Credit Scoring service (e.g., item 502) regarding the occurrence of the transactions. In some embodiments, the Credit Scoring service uses mathematical modelling and machine learning to calculate the credit score of the client. The resultant credit score is saved in the relevant client's profile to enable the client to have a constant view of their current credit score in substantially real time. If the payments made were towards savings, record of the nature of the payment will be sent to the Credit Scoring service by the Savings Management service (e.g., item 504) to allow these payments to be factored into the credit score. The classification of various types of payments into categories such as rental payments, bill payments, average transaction account balance, and savings payments, allows the system to determine a more accurate credit score, as these types of payments have weightings and distinctive effects on the client's relevant credit score. On the completion of the credit score calculation, the Credit Scoring service stores the relevant resultant credit scoring data in its database, and then proceed to issue a message to the Pricing and Recommendation services (e.g., items 503 and 505, respectively).

The Pricing service allows for the determination of dynamic interest rates and insurance premiums that automatically adjust, in accordance with the client's transaction history as calculated by the Credit Scoring service and based on information provided on financial products provided by external financial service providers (such as banks, insurance companies, pension fund managers, and other lenders). Therefore, according to some embodiments, each time an event causes the client's credit score to change, it triggers a recalculation of their resultant customized pricing (across interest rates and premiums), based on the new credit score and various prevailing macroeconomic variables. On completion, the Pricing service stores its relevant resultant pricing data in its corresponding database (e.g., in a database (e.g., one or more of Databases 511)) via a Data Access Layer 506 through which the services store various data). Additionally, this data is saved to the client's profile to enable a client to view the current estimated pricing for various recommended and customized financial products that the client could qualify for, and to monitor how each specific transaction(s) influences this pricing.

In the pre-qualification phase, insurance providers and pension fund managers provide data on their products (which include a bundled combination of home insurance, life insurance, medical insurance, etc.) and pension contributions, which is linked to the recommendation service. Within the recommendation service, the data is combined with that provided by lenders on mortgages in order to create a customized and optimized financial products bundle based on individualized credit scores and affordability. Each specific user can opt-into their customized/optimized financial products bundle (which includes insurance and pension products) at the point of qualifying for a mortgage. In the post-qualification phase, the Insurance and Pension transaction data on the premium and contribution payment patterns of the user are tracked, while also fetching updated and new data on insurance and pension products that a user could potentially qualify for. Should a more optimal financial bundle emerge, this is reflected in the recommendation service—when a user opts into the new bundle, the service switches them from their current insurance and/or pension provider to the new one. When insurance and pension providers make payouts to a user the data is updated on their profile and pushed to the user's device as a notification of the update to their accounts.

The Reporting service manages all workflows related to the generation of reports, including detailed user credit reports as may be requested by FSPs. This also incorporates a back-office service that allows back-office users and participating external financial services providers to query various kinds of information and user credit reports from the system, for example how many users are in the system, what transactions occurred on a particular day, which users have a credit score higher than a certain value, and pulling out the credit reports of specific users, etc. This allows for easy querying of various levels of information for authorized users, including external financial services providers who can access this service via the public API.

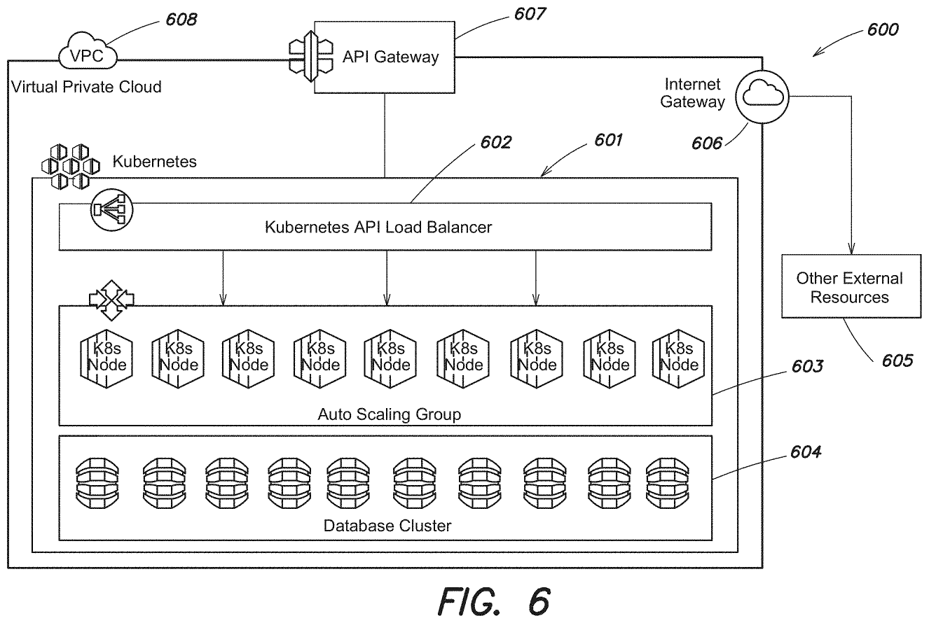

A typical layout of the network architecture 600 of the system in accordance with the invention is illustrated in FIG. 6. External communications to the system are done, for example, through the Client Applications that connect to the system via any communication device with internet access.

The first point of contact with the system is via the API gateway 607 that contains a load balancer and service register that it uses to route requests to the respective service modules. The internal network runs on, for example, a Kubernetes application hosting system which allows for the deployment and management of containerized microservice clusters. Kubernetes manages deployment, maintenance and scaling of the clusters of compute instances which run the containerized microservices based on the available compute resources and the resource requirements of each container. This allows running and scaling of containers as a logical group and allows the system (e.g., a Notto service) to adjust to demand.

The Kubernetes system (item 601) includes a load balancer 602, an autoscaling group of nodes (e.g., item 603) and a database cluster (e.g., item 604). The Kubernetes system is also coupled to one or more external resources (e.g., item 605) via one or more Internet or private gateways (e.g., item 606).

The system uses the Kubernetes platform according to various embodiments because it internally, and intelligently, determines where and when to run the logical groups of microservices and it manages traffic routing and scales the logical groups based on utilization and/or other metrics. Kubernetes will intelligently start more compute instances when demand increases or stop some compute instances when demand reduces so that at any given instance there are enough copies of a specific microservice to deal with the demand. In this way, the failure of any particular compute instance or microservice does not affect the rest of the system and the system can handle scaling gracefully. Additionally, it will automatically restart any compute instances if they or the instances they are running on fail. Although Kubernetes may be used as a platform to implement one or more services, it should be appreciated that other systems and services may be used to implement various embodiments, and that the system is not limited thereto.

### Example System Architecture

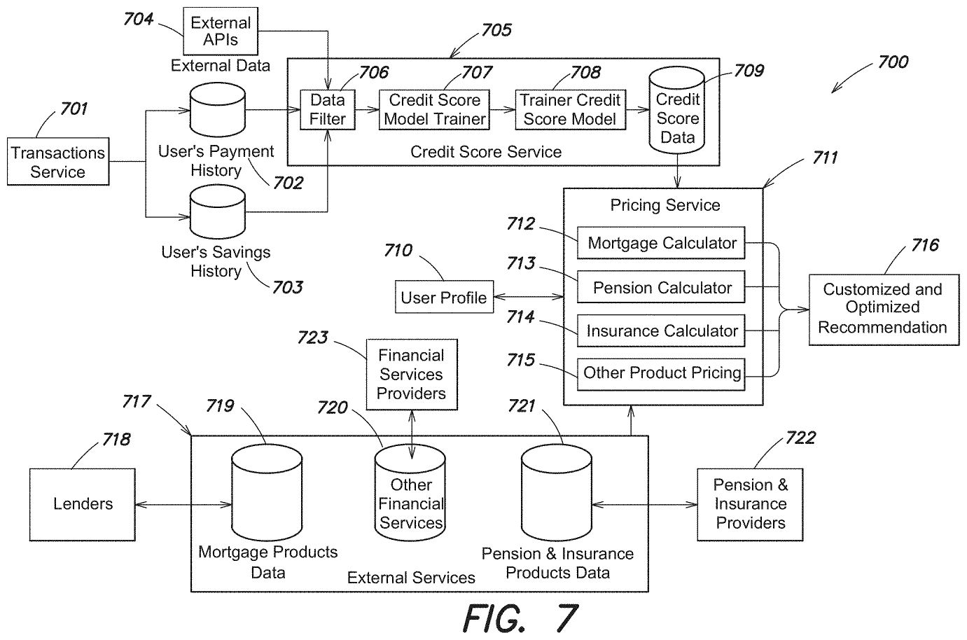

FIG. 7 shows an example distributed computer-based architecture that may be used to implement various embodiments. In particular, FIG. 7 shows various relations between transactions, credit scoring, external, pricing and recommendation services according to some embodiments. As shown, a transactions service 701 provides transaction information which can be then stored in a user's payment history 702 and/or a user's savings history 703. Further, external transaction information may be received from one or more third-party systems via external APIs 704. Such information may be received and processed by a credit score service 705.

Credit score service 705 may be a service that is capable of receiving transaction data and calculating a credit score for a particular user at any point in time in real time. Such transaction information may be inputted into a data filter 706 which filters and presents relevant data to a credit score model trainer 707 upon which a neural network or other machine learning engine may be trained. In some embodiments, the system may be capable of training a model in near real time to provide the most relevant credit score data. At block 708, as a result of a training operation, a trained credit score model is produced at block 708. As a result of receiving transaction information, the model may produce one or more credit scores for various users and store the information as credit score data at block 709.

In some embodiments, the system may also include a pricing service 711 which determines pricing of particular products based on updated credit score data (e.g., as received by the credit score service 705) and user profile information 710. Pricing service 711 may include one or more elements including, but not limited to, a mortgage calculator 712, a pension calculator 713, an insurance calculator 714, or a pricing module for some other type of product (e.g., element 715). Pricing service 711 is configured to produce a customized and optimized recommendation to a particular user based on their profile information and updated credit score data (e.g., at block 716).

As an input to pricing service of 711, one or more external services 717 may be linked with the pricing service, such as mortgage products, financial services, pension and insurance, among other services. For example, lenders 718 may communicate mortgage products data 719 which may be matched to the user based on their profile and credit score data. Further, one or more financial service providers 723 may provide other financial services 720 determined similarly based on the match between data 720 and the user's profile in credit score data. The system may also provide, from pension and insurance providers 722, one or more pension and insurance products based on a matching operation with the pension and insurance products data 721.

In some embodiments, the payment for such services may be bundled with a person's mortgage or other financial arrangement. In some cases, credit scores may be calculated periodically and updated and optimized recommendations may be provided to the user in the form of products that can be purchased with the savings calculated by the updated credit score.

### Artificial Neural Network (ANN) for Credit Score Calculation

People are generally locked into an interest rate that represents their behavior in the past regardless of how much their behavior has changed along the way. In some embodiments described herein, credit scores are dynamic and they change with the user's behavior. Therefore financial product pricing, which is based on the credit score should also be dynamic, representing the user's current credit worthiness. In some embodiments, a machine learning engine may be employed to determine changes in credit score responsive to user behavior. Such a credit score may be used to determine a credit score outright, or may be used with other more conventional credit scores to determine adjustments in a credit score and/or to determine a composite score (e.g., combining multiple credit score via a weighted average).

In some embodiments described herein, Artificial Neural Networks (ANN) are very well suited for making this dynamic credit score possible. Neural networks form the base of deep learning, a subset of machine learning where the algorithms are inspired by the structure of the human brain. They take in data, train themselves to recognize the patterns in this data and produce the outputs for a new set of similar data.

While the present techniques are susceptible to various modifications and alternative forms, specific embodiments are given by way of example and will be described here. It should be understood that the explanations and drawings given here are not intended to limit the techniques to the particular form disclosed, but to the contrary, the intention is to also cover all modifications, equivalents, and alternatives falling within the spirit and scope of the present techniques as defined by the description and claims given above.

The value of the artificial neural network is in the fact that it does not just look at the weighted sum of the independent variables but also considers the weighted combinations of the values and their effect on the overall result that aren't obvious, giving an additional or multiple additional layers of consideration that just a simple regression model would not manage in any reasonable manner.

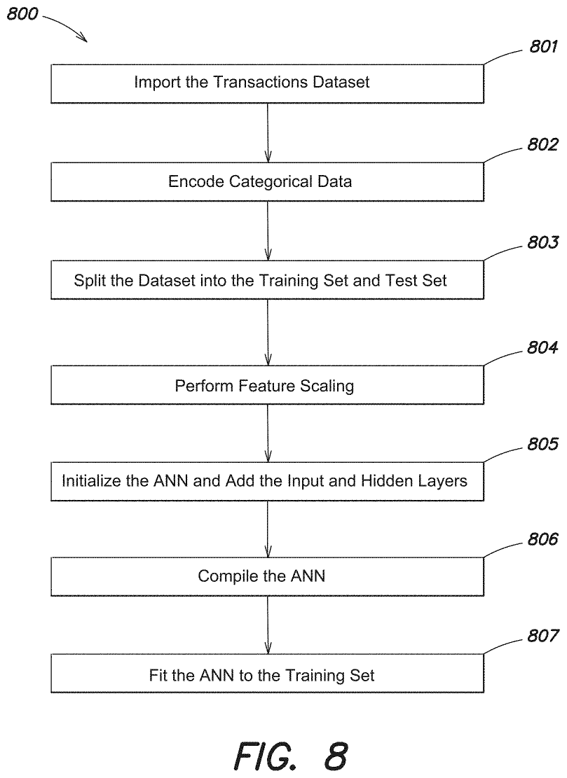

The diagram shown by way of example in FIG. 8 represents the flow and treatment of data, in a process 800 for using artificial neural networks for the computation of credit scores. At block 801, the system imports a transactions data set. As discussed above, such a data set may include financial transactions associated with one or more payment accounts.

At block 802, the system encodes categorical data associated with the transactions. At block 803, the data set may be split into a training set in a test set. At block 804, the system performs feature scaling (e.g., by normalizing or standardizing input and output variables). At block 805, the ANN is initialized and input and hidden layers are added. At block 806, the ANN is compiled, and at block 807, the ANN is fitted to the training set.

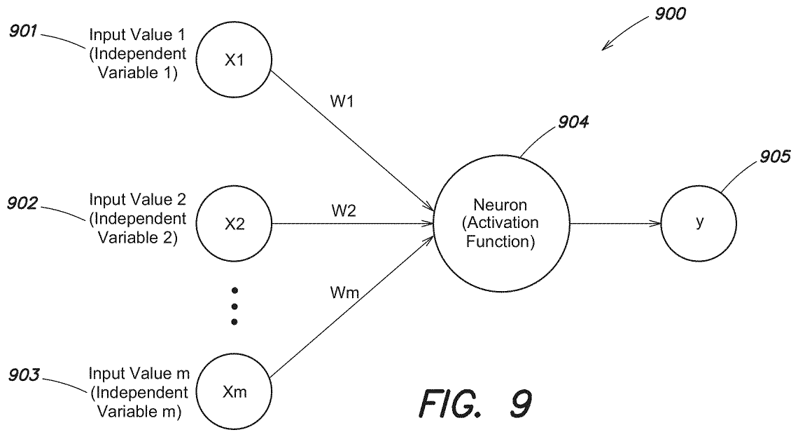

FIG. 9 shows an overview of a process 900 by which independent variables elements 901-903) are assigned particular weightings/coefficients (W1, W2, Wm) on the basis of an to activation function (904) for the Artificial Neural Network to compute a score (y) (element 905).

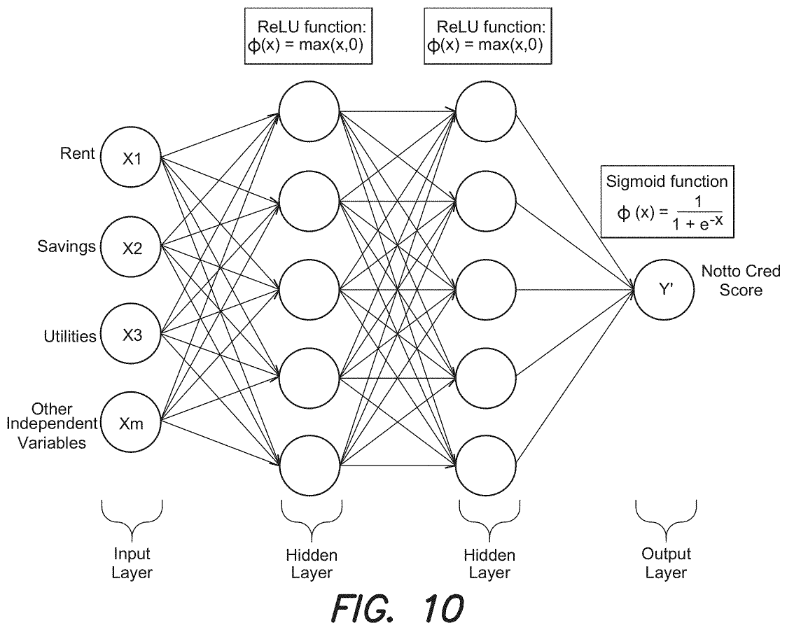

FIG. 10 shows one embodiment of a detailed ANN which can be used to calculate a credit score. As can be seen from the FIG. 10, the ANN shown takes in inputs (independent variables), determined through actuarial models. In particular, the following differential equation forms the basis of the model—through the deep learning/artificial neural network process, the weightings in the differential equation are refined, building on an initial hypothesis which is tested against real consumer behavior and data:

dCredit score(t)=φ(Rent)dt+ω(Savings)dt+μ(Utilities)dt+β(Xm)dt

The following is a brief outline of the choices of algorithms used for the model.
The neurons
   The basic is that the neuron has several inputs, these inputs are independent variables relating to a single observation.
   These independent variables are standardized, that is they need to have a mean of zero and a variance of one. This is so that all the inputs are within a similar range.
   In the case of some embodiments described herein, the output of the model will be a continuous value output representing the credit score or the probability of creditworthiness.
   Inside the neurons a few things happen;
      firstly they take the weighted sum of all the inputs

Σᵢ₌₁^{m}Wi·Xi
Next, an activation function is applied to this weighted sum and a bias value is added and the result is the signal passed down the line (more on the activation function below);

Φ(Σᵢ₌₁^{m}Wi·Xi)+b
This same process is repeated in the whole neural network on all the neurons.
The activation function
   The predominant types of activation function are;
      Threshold function
      Sigmoid function
      ReLU function
      Hyperbolic tangent function
   In the present invention, the function is used in the hidden layers of the neural network and then the sigmoid in the output neuron.
The cost function is used by the ANN to determine how good a prediction it made in each learning cycle. The present technique used is the simple gradient descent cost function:

$$C = \sum \frac{1}{2} {( {y}^{′} - y )}^{2}$$

The ANN uses gradient descent to calculate the values of the weights needed to minimise the cost function,
   Training the Credit Scoring ANN with Stochastic Gradient Descent
Note that this process is done using real data generated from users of the system, and from the various services in the system architecture:
   1. Randomly initialize the weights to small numbers close to 0 (but not 0), for this formula:

dCredit score(t)=φ(Rent)dt+ω(Savings)dt+μ(Utilities)dt+β(Xm)dt
2. Input the first observation of the training dataset in the input layer, each feature in one input node—this means that the number of nodes in the input layer of a credit scoring model is the number of independent variables in our credit scoring equation.
3. Forward-Propagation: the neurons are activated in a way that the impact of each neuron's activation is limited by the weights. Propagate the activations until getting the predicted result. While there are several activation functions, a rectifier function may be used for the nodes and the sigmoid function for the output layer to get probabilities in the final result.

$$Rectifier - ϕ ( x ) = max ( x , 0 ) , Sigmoid - ϕ ( x ) = \frac{1}{1 + {e}^{- x}}$$

4. Compare the predicted result to the actual result. Measure the generated error.
5. Back-Propagate: the error is back-propagated. Update the weight according to how much they are responsible for the error. The learning rate decides by how much the weights are updated.
6. Repeat steps 1 to 5 and update the weights only after a batch of observations (e.g., using batch learning as opposed to reinforcement learning).
7. When the whole training set has passed through the ANN, that makes an epoch. Redo more epochs as more data is acquired to improve the ANN's predictive accuracy, and achieve a more accurate dynamic credit score to input into the pricing service.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that one implementation of the embodiments comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments. The computer-readable storage medium can be transportable such that the program stored thereon can be loaded onto any computer resource to implement the aspects discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects.

Various aspects may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including”, “comprising”, “having”, “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A system comprising:
a transaction processing module adapted to receive transaction information from one or more entities, the transaction information relating to financial transactions made by a user;
at least one memory unit, coupled to the transaction processing module, configured to store the transaction information relating to the financial transactions made by the user;
means for determining, for the user, an individually-determined credit score for the user based on, at least in part, the transaction information relating to the financial transactions made by the user.

2. The system according to claim 1, further comprising a credit score computation module, coupled to the at least one memory unit, the credit score computation module being configured to interrogate the at least one memory unit and calculate a predicted credit score associated with the user as a function of the transaction data in the at least one memory unit, and to store the resultant predicted credit score in the at least one memory unit.

3. The system according to claim 1, wherein the at least one memory unit is adapted to store data associated with the user, the data including at least one of a group comprising:
user identification data;
user transaction records;
credit score data of the user;
customized pricing data associated with the user;
savings data of the user;
pension contribution data; and
insurance premium payment data of the user.

4. The system according to claim 1, wherein the transaction module is adapted to receive one or more transaction data elements from one or more third party systems.

5. The system according to claim 1, wherein the transaction module is configured to poll or scrape, with the user's permission, user transactions from one or more separate user accounts.

6. The system according to claim 4, wherein the one or more third party systems include at least one or more of the group of systems comprising:
a payment provider system;
a banking system;
a mobile money account system;
a digital payments system; and
a computer-based system that stores financial transaction data for transactions conducted by the user.

7. The system according to claim 1, wherein the transaction module is adapted to receive and process information identifying a proof of payment from a third party, and wherein the system further comprises a verification module that is adapted to verify at least one of the financial transactions made by the user using the information identifying a proof of payment.

8. The system according to claim 7, wherein the verification module is configured to determine an existence of one or more binding legal agreements to support the validity of transactions as bona fide between the user and respective service providers.

9. The system according to claim 8, wherein the service providers include at least one of a group comprising a landlord, a utility provider, a school or institution for learning, a banking account or savings institution, or other service provider that accepts a payment for services.

10. The system according to claim 2, further comprising a machine learning unit, coupled to the at least one memory unit and the credit score computation module, the machine learning unit being configured to train a machine learning model to optimize credit score coefficients using data associated with a plurality of other users.

11. The system according to claim 10, wherein the machine learning unit is configured to store resultant data in the at least one memory unit for future interrogation by the credit score computation module to determine another credit score.

12. The system according to claim 1, further comprising a pricing computation module, coupled to the at least one memory unit, the pricing computation module being configured to interrogate the at least one memory unit and calculate optimal pricing associated with the user as a function of a group comprising credit store data, pricing models for one or more financial products and preselected macroeconomic indicators and wherein the pricing computation module is configured to store the calculated optimal pricing store for each user across financial products in the at least one memory unit.

13. The system according to claim 12, wherein the system further comprises a recommendations module, coupled to the at least one memory unit, and wherein the recommendations module is adapted to poll product information from at least one of a group comprising external financial services providers, pension providers, and insurance providers and wherein the recommendations module is configured to compute personalized bundled product recommendations for a respective user within the constraints of the respective user's affordability and their individualized credit score.

14. The system according to claim 13, wherein the system is configured to capture and categorize each successive transaction made by the user, and triggering, responsive to the successive transaction, a recalculation of the user's credit score by the credit score computation module, and the recalculation of the user's customized pricing for loan, insurance and savings products by the pricing computation module and the recalculation of the user's recommendations by the recommendations module.

15. A computer-implemented method comprising:
receiving transaction information from one or more entities, the transaction information relating to financial transactions made by a user;
storing, in a memory unit, the transaction information relating to the financial transactions made by the user;
determining for the user substantially in real-time an individually-determined credit score for the user based on, at least in part, the transaction information relating to the financial transactions made by the user.

16. The method according to claim 15, further comprising an act of predicting the individually-determined credit score associated with the user as a function of the transaction data in the memory unit, and to store the resultant predicted credit score in the at least one memory unit.

17. The method according to claim 15, further comprising, storing, by the memory unit, data associated with the user, the data including at least one of a group comprising:
user identification data;
user transaction records;
credit score data of the user;
customized pricing data associated with the user;
savings data of the user;
pension contribution data; and
insurance premium payment data of the user.

18. The method according to claim 15, further comprising receiving one or more transaction data elements from one or more third party systems.

19. The method according to claim 15, further comprising polling, with the user's permission, user transactions from one or more separate user accounts.

20. The method according to claim 19, wherein the one or more third party systems include at least one or more of the group of systems comprising:
a payment provider system;
a banking system;
a mobile money account system;
a digital payments system; and
a computer-based system that stores financial transaction data for transactions conducted by the user.

21. The method according to claim 15, further comprising receiving and processing information identifying a proof of payment from a third party, and verifying at least one of the financial transactions made by the user using the information identifying a proof of payment.

22. The method according to claim 21, further comprising determining an existence of one or more binding legal agreements to support the validity of transactions as bona fide between the user and respective service providers.

23. The method according to claim 22, wherein the service providers include at least one of a group comprising a landlord, a utility provider, a school or institution for learning, a banking account or savings institution, or other service provider that accepts a payment for services.

24. The method according to claim 16, further comprising training a machine learning unit to optimize credit score coefficients using data associated with a plurality of other users.

25. The method according to claim 24, further comprising storing, by the machine learning unit, resultant data in the at least one memory unit for future interrogation to determine another credit score.

26. The method according to claim 15, further comprising interrogating the one memory unit and calculating optimal pricing associated with the user as a function of a group comprising credit store data, pricing models for one or more financial products and preselected macroeconomic indicators and storing the calculated optimal pricing store for each user across financial products in the memory unit.

27. The method according to claim 26, further comprising polling product information from at least one of a group comprising external financial services providers, pension providers, and insurance providers and computing personalized bundled product recommendations for a respective user within the constraints of the respective user's affordability and their individualized credit score.

28. The method according to claim 27, further comprising capturing and categorizing each successive transaction made by the user, and triggering, responsive to the successive transaction, a recalculation of the user's credit score by the credit score computation module, and the recalculation of the user's customized pricing for loan, insurance and savings products by the pricing computation module and the recalculation of the user's recommendations.

29. A method comprising:
capturing user transactions via an API gateway that is integrable with at least one payment or transaction tracking method;
storing data associated with the user, including user identification data, user transaction records, user credit score data, user customized pricing data, user recommendations, and user savings data;
processing and categorizing user transactions into groups including rental payments, bill payments, savings payments and storing the resultant transaction data;
calculating a credit score associated with the user as a function of the transaction data and storing the resultant credit score data;
training a machine learning model to optimize credit score coefficients as a function of the data associated with each of the plurality of the other users and storing the resultant data for future credit score calculations.

30. The method according to claim 29, further comprising calculating an optimized pricing associated with the user as a function of the credit score data, available financial products provided by financial institutions and storing the resultant customized pricing data.

31. The method according to claim 30, further comprising creating personalized bundled product recommendations within the constraints of the user's affordability and individualized credit score, based on the products offered by the financial services, insurance and pension providers.

32. The method according to claim 31, wherein each transaction made by a user is captured and categorized, and each transaction prompts a recalculation of the user's credit score and the recalculation of the user's interest rate and bundled product recommendations.

33. A method comprising:
capturing user transactions via an API gateway that is integrable with at least one payment or transaction tracking method;
storing data associated with the user, including user identification data, user transaction records, user credit score data, user customized pricing data, user recommendations, and user savings data;
processing and categorizing user transactions into groups including for an extant bundled financial product that the user opts into (i.e., mortgage repayments, pension contribution payments, insurance premium payments), rental payments, bill payments, savings payments and storing the resultant transaction data;
calculating a credit score associated with the user as a function of the transaction data and storing the resultant credit score data;
training a machine learning model to optimize credit score coefficients as a function of the data associated with each of the plurality of the other users and storing the resultant data for future credit score calculations.

34. The method according to claim 33, further comprising calculating an optimized pricing associated with the user as a function of the credit score data, available financial products provided by financial institutions and storing the resultant customized pricing data.

35. The method according to claim 34, further comprising creating personalized bundled product recommendations within the constraints of the user's affordability and individualized credit score, based on the products offered by the financial services, insurance and pension providers.

36. The method according to claim 35, wherein each transaction made by a user is captured and categorized, and each transaction prompts a recalculation of the user's credit score and the recalculation of the user's interest rate and bundled product recommendations.
